(19) United States
(12) Patent Application Publication
(10) Pub. No.: US 2018/0020222 A1
(43) Pub. Date: Jan. 18, 2018

(54) Apparatus and Method for Low Latency Video Encoding

(71) Applicant: MEDIATEK INC., Hsin-Chu (TW)

(72) Inventors: Tung-Hsing WU, Chiayi City (TW); Chung-Hua TSAI, Kaohsiung City (TW); Wei-Cing LI, Hsinchu City (TW); Lien-Fei CHEN, Taoyuan City (TW); Li-Heng CHEN, Tainan City (TW); Han-Liang CHOU, Hsinchu County (TW); Ting-An LIN, Hsinchu City (TW); Yi-Hsin HUANG, Taoyuan County (TW)

(21) Appl. No.: 15/642,586

(22) Filed: Jul. 6, 2017

Related U.S. Application Data
(60) Provisional application No. 62/374,966, filed on Aug. 15, 2016.
(60) Provisional application No. 62/364,908, filed on Jul. 21, 2016.
(60) Provisional application No. 62/361,108, filed on Jul. 12, 2016.

(51) Int. Cl. H04N 19/152; H04N 19/85; H04N 19/423

(52) U.S. Cl. CPC H04N 19/152; H04N 19/423; H04N 19/85

(57) ABSTRACT

An apparatus and method for video encoding with low latency is disclosed. The apparatus comprises a video encoding module to encode input video data into compressed video data, one or more processing modules to provide the input video data to the video encoding module or to further process the compressed video data from the video encoding module, and one data memory associated with each processing module to store or to provide shared data between the video encoding module and each processing module. The encoding module and each processing module are configured to manage data access of one data memory by coordinating one of the video encoding module and one processing module to receive target shared data from one data memory after the target shared data from another of the video encoding module and one processing module are ready in said one data memory.

### CROSS REFERENCE TO RELATED APPLICATIONS

The present invention claims priority to U.S. Provisional Patent Application, Ser. No. 62/361,108, filed on Jul. 12, 2016, U.S. Provisional Patent Application, Ser. No. 62/364,908, filed on Jul. 21, 2016 and U.S. Provisional Patent Application, Ser. No. 62/374,966, filed on Aug. 15, 2016. The U.S. Provisional Patent Applications are hereby incorporated by reference in their entireties.

### FIELD OF THE INVENTION

The present invention relates to video coding. In particular, the present invention relates to very low-latency video encoding by managing data access and processing timing between processing modules.

### BACKGROUND

Video data requires a lot of storage space to store or a wide bandwidth to transmit. Along with the growing high resolution and higher frame rates, the storage or transmission bandwidth requirements would be formidable if the video data is stored or transmitted in an uncompressed form. Therefore, video data is often stored or transmitted in a compressed format using video coding techniques. The coding efficiency has been substantially improved using newer video compression formats such as H.264/AVC, VP8, VP9 and the emerging HEVC (High Efficiency Video Coding) standard. In order to maintain manageable complexity, an image is often divided into blocks, such as macroblock (MB) or LCU/CU to apply video coding. Video coding standards usually adopt adaptive Inter/Intra prediction on a block basis.

In a video coding system, the involved encoding and decoding process usually requires lots of computations. These computations may cause some delays in the encoder side as well as in the decoder side. For real-time applications such as live broadcast, large delay may be undesirable. For interactive applications, such as tele-presence, the long delay may become annoying and cause bad user experience. Therefore, it is desirable to design a video coding system with very low delay.

FIG. 1 illustrates an example of a video link from a source to a sink involving video encoding at the source end and video decoding at the sink end. The video link source end may correspond to a video recording or transmission system to generate compressed video data for recording or transmission. The video link sink end may correspond to a video player or receiving system to generate decoded video data for display. The compressed video may be stored in various storage media for the recording applications or transmitted via Wi-Fi, internet or other transmission environment. In FIG. 1, system 110 corresponds to the recording or transmission system and system 120 corresponds to the playback or receiving system. In the recording or transmission system 110, the video source is encoded using video encoder 112 to generate compressed video. Often, the system also includes associated audio data. Audio/Video (A/V) signals are combined using A/V multiplexer (A/V MUX) 114. The multiplexed audio and video data can be recorded or transmitted. In FIG. 1, an example of transmitting the multiplexed audio and video data using Wi-Fi MAC 116 (media access controller) is shown. In the playback or receiving system 120, the video bitstream is decoded using video decoder 122 to generate decoded video for display on display engine 124. The associated audio data may be de-multiplexed using A/V de-multiplexer (A/V DEMUX) 126. In FIG. 1, an example of receiving the multiplexed audio and video data using Wi-Fi MAC 128 is shown.

The video data usually is generated and displayed at a pre-defined frame rate. For example, the video may have a frame rate of 120 fps (frames per second). In this case, each frame period corresponds to 8.33 ms (millisecond). For real-time processing, each frame needs to be encoded of decoded within 8.33 ms. FIG. 2A illustrates an example of video recording path in the recording system, where the video source is encoded using video encoder 210 to generate video bitstream. The video bitstream is then multiplexed with audio data by MUX (multiplexer) 212 to generate compressed A/V data for storage or transmission. Both video encoder 210 and MUX (multiplexer) 212 will take time to process underlying data. There is processing latency from the moment for a block of video data entering the video encoder 210 to the moment for corresponding compressed data exiting the MUX 212. This latency is called recording or transmission latency. FIG. 2B illustrates an example of video playback path in a playback system, where the compressed A/V data are de-multiplexed by de-multiplexer (DEMUX) 220 to extract the video bitstream, which is provided to video decoder 222 to generate reconstructed frames for display 224. The de-multiplexer 220, video decoder and display 224 will take time to process underlying data. There is processing latency from the moment for A/V data associated with a block of video data entering the DEMUX 220 to the moment for corresponding reconstructed data being displayed on display 224. This latency is called playback or receiving latency. In a video link, the end to end latency (i.e., (recording latency+playback latency) or (transmission latency+receiving latency)) plays an important role in some video applications, such as for real-time applications. It is a design goal for the present invention to minimize the end to end latency for a video link. For example, the latency can be measured in the unit of frame period. Therefore, the goal of the present invention minimizes the latency to ensure that the latency is below N frame periods. In another example, the latency is measured in the unit of millisecond. Therefore, the goal of the present invention minimizes the latency to ensure that the latency is below x ms.

FIG. 3 illustrates an exemplary adaptive Inter/Intra video coding system incorporating loop processing. For Inter-prediction, Motion Estimation (ME)/Motion Compensation (MC) 312 is used to provide prediction data based on video data from other picture or pictures. Switch 314 selects Intra Prediction 310 or Inter-prediction data and the selected prediction data is supplied to Adder 316 to form prediction errors, also called residues. The prediction error is then processed by Transform (T) 318 followed by Quantization (Q) 320. The transformed and quantized residues are provided to Rate Distortion Optimization (RDO)/Mode Decision unit 321 to evaluate the cost in terms of rate and distortion for an associated coding mode. The encoder then selects a mode that achieves the best performance measured in the rate-distortion cost. The transformed and quantized residues are then coded by Entropy Encoder 322 to be included in a video bitstream corresponding to the compressed video data. The bitstream associated with the transform coefficients is then packed with side information such as motion, coding modes, and other information associated with the image area. The side information may also be compressed by entropy coding to reduce required bandwidth. When an Inter-prediction mode is used, a reference picture or pictures have to be reconstructed at the encoder end as well. Consequently, the transformed and quantized residues are processed by Inverse Quantization (IQ) 324 and Inverse Transformation (IT) 326 to recover the residues. The residues are then added back to prediction data 336 using Adder 328 to reconstruct video data. The reconstructed video data may be stored in Reference Picture Buffer 334 and used for prediction of other frames. However, the reconstructed video data from REC 328 may be subject to various impairments due to a series of processing. Accordingly, Loop filter 330 (e.g. De-blocking) is often applied to the reconstructed video data before the reconstructed video data are stored in the Reference Picture Buffer 334 in order to improve video quality. For example, deblocking filter (DF) and Sample Adaptive Offset (SAO) have been used in the High Efficiency Video Coding (HEVC) standard. The loop filter information may have to be incorporated in the bitstream so that a decoder can properly recover the required information. Therefore, loop filter information is provided to Entropy Encoder 322 for incorporation into the bitstream. In FIG. 3, Loop filter 330 (e.g. de-blocking filter) is applied to the reconstructed video before the reconstructed samples are stored in the reference picture buffer 334. The system in FIG. 3 is intended to illustrate an exemplary structure of a typical video encoder. It may correspond to the High Efficiency Video Coding (HEVC) system or H.264.

FIG. 4 illustrates a system block diagram of a corresponding video decoder for the encoder system in FIG. 3. The overall decoding system is divided into two parts: syntax parser 410 and post decoder 420. Since the encoder also contains a local decoder for reconstructing the video data, some decoder components are already used in the encoder except for the entropy decoder 412. Furthermore, only motion compensation 422 is required for the decoder side. The switch 424 selects Intra-prediction or Inter-prediction and the selected prediction data are supplied to reconstruction unit (REC) 328 to be combined with recovered residues. Besides performing entropy decoding on compressed residues, entropy decoding 412 is also responsible for entropy decoding of side information and provides the side information to respective blocks. For example, motion vectors are decoded and stored in MV buffer 414. The MVs are then provided to motion compensation 422 for locating reference blocks. The residues are processed by IQ 324, IT 326 and subsequent reconstruction process to reconstruct the video data. Again, reconstructed video data from reconstruction unit (REC) 328 undergo a series of processing including IQ 324 and IT 326 as shown in FIG. 4. and are subject to coding artifacts. The reconstructed video data are further processed by Loop filter 330.

In video coding system, a frame is often partition into multiple slices to offer the capability for parallel processing. Also, the slice structure may limit data dependency within each slice. The “slice” term has been commonly used in various video coding standards, such as MPEG2/4, H.264, HEVC, RM, AVS/AVS2, etc. Furthermore, the basic coding unit has also been used of video standard. For example, Macroblock (MB) has been used in AVC, MPEG4, etc. Super Block (SB) has been used in VP9 standard. Coding Tree Unit (CTU) has been used in HEVC (high efficiency video coding). Furthermore, a coding structure, the CTU Row, SB row and MB row have also been used. In order to increase video compression ratio, spatial reference data and temporal reference data are used for prediction. FIG. 5 illustrates an example of spatial and temporal prediction, where frame 510 is processed before frame 520. Each frame is partitioned into tiles and each tile is partitioned into multiple PUs. For frame 510, PU_A can be used as spatial reference data (i.e., the above neighbor) by PU_B. Also, PU_A can be used as temporal reference data (co-located data) by PU_C.

For entropy coding, it comes in various flavors. Variable length coding is a form of entropy coding that has been widely used for source coding. Usually, a variable length code (VLC) table is used for variable length encoding and decoding. Arithmetic coding (e.g. context-based adaptive binary arithmetic coding (CABAC)) is a newer entropy coding technique that can exploit the conditional probability using “context”. Furthermore, arithmetic coding can adapt to the source statistics easily and provide higher compression efficiency than the variable length coding. While arithmetic coding is a high-efficiency entropy-coding tool and has been widely used in advanced video coding systems, the operations are more complicated than the variable length coding. Both types of entropy coding methods are rather timing consuming. Accordingly, entropy encoding/decoding often becomes the bottleneck of the system.

As is well known in the field, a higher bitrate will lead to better video quality. At higher bitrates, the post decoder processing is relatively bitrate independent. However, at higher bitrates, there will be more number of non-zero quantized residues that need to be entropy coded. Therefore, the computational loading for entropy encoding and decoding increases for higher bitrates. Therefore, the computational loads of entropy decoding are sensitive to the bitrate and entropy decoding becomes the performance bottleneck of video decoding, especially at higher bitrates. Accordingly, higher bitrate bitstreams cause larger latency. Therefore, it is desirable to use entropy decoding design with the highest bitrate limit according to its capability. When the bitrate of the video bitstream is higher than a limit, other solutions should be developed instead of using a single entropy decoding design.

FIG. 6 illustrates an example of HEVC wavefront parallel processing (WPP). Each frame is partition into multiple slices, where each slice corresponds to one CTU row. WPP reduces syntax coding dependency between CTU rows. CTU rows can be processed in parallel by using WPP method. In the HEVC standard, when the bitstream is encoded according to WPP, syntax “entropy_coding_sync_enabled_flag” will be set to 1. According to WPP, after a number of blocks in a previous CTU row have been processed, the first block of the current CTU can be processed. In the example of FIG. 6, after a block (AO) in the third CTU of the previous CTU row is processed, the first block (e.g. B₀) in the first CTU of the current CTU row can be processed. For a current block 610 in CTU Row 1, the block can use information from neighboring blocks in the same CTU Row processed prior to the current block. Also, the current block in CTU Row 1 can use information from neighboring blocks 620 in the previous CTU Row.

In order to reduce the latency in the recording/transmission side, the playback/receiving side or the total latency on both sides, a system is disclosed that coordinates data access and process timing among different processing modules and/or within each processing module.

### BRIEF SUMMARY OF THE INVENTION

An apparatus for video encoding with low latency is disclosed. The apparatus comprises a video encoding module to encode input video data into compressed video data; one or more processing modules to provide the input video data to the video encoding module or to further process the compressed video data from the video encoding module; and one data memory associated with each of said one or more processing modules to store or to provide shared data between the video encoding module and said each of said one or more processing modules. According to present invention, the encoding module and said each of said one or more processing modules are configured to manage data access of said one data memory by coordinating one of the video encoding module and said each of said one or more processing modules to receive target shared data from said one data memory after the target shared data from another of the video encoding module and said each of said one or more processing modules are ready in said one data memory.

Said one or more processing modules may comprise a front-end processing module and said one data memory associated with the front-end processing module corresponds to a first memory. In this case, the front-end processing module provides first pixel data corresponding to a first coding data set of one video segment to store in the first memory and the video encoding module receives and encodes second pixel data corresponding to one or more blocks of the first coding data set of one video segment when said one or more blocks of the first coding data set of one video segment in the first memory are ready. The first coding data set of one video segment can be encoded by the video encoding module into a first bitstream. In this case, a size of the first bitstream is limited to be equal to or smaller than a maximum size and the maximum size can be determined before encoding the first coding data set of one video segment. Furthermore, the maximum size can be determined based on decoder capability, recording capability or network capability associated with a target video decoder, a target video recording device or a target network that is capable of handling compressed video data.

In one embodiment, the front-end processing module corresponds to an ISP (image signal processing) module, the first memory corresponds to a source buffer and the first coding data set of one video segment corresponds to a block row. The ISP module may provide the first pixel data on a line by line basis and the video encoding module starts to encode one or more blocks of the first coding data set of one video segment after the first pixel data for the block row are all stored in the first memory. The ISP module may also provide the first pixel data on a block by block basis and the video encoding module starts to encode one block of the first coding data set of one video segment after the first pixel data for a number of blocks are stored in the first memory.

The first memory may correspond to a ring buffer with a fixed size smaller than a video segment. Each video frame may comprise one or more video segments. The first coding data set of one video segment may comprise a plurality of coding units. Also, the first coding data set of one video segment may correspond to a CTU (coding tree unit) row, a CU (coding unit) row, an independent slice or a dependent slice.

Said one or more processing modules may further comprise a post-end processing module and said one data memory associated with the post-end processing module corresponds to a second memory. In this case, the video encoding module may provide packed first bitstream corresponding to compressed data of the first coding data set of one video segment to store in the second memory and the post-end processing module processes the packed first bitstream for recording or transmission after the packed first bitstream in the second memory are ready. The post-end processing module may correspond to a multiplexer module and the multiplexer module multiplexes the packed first bitstream with other data including audio data into multiplexed data for recording or transmission. The multiplexer module may derive one video channel index or time stamp corresponding to the said video segment to include in the multiplexed data. The second memory may correspond to a ring buffer. A size of the second memory may correspond to a source size of two coding unit rows of one video segment.

In one embodiment, a write pointer or indication corresponding to an end point of one first data unit in one data memory being written is signaled from the front-end processing module to the video encoding module or from the video encoding module to the post-end processing module. Furthermore, a read pointer or indication corresponding to an end point of one second data unit in one data memory being read can be signaled from the video encoding module to the front-end processing module or from the post-end processing module to the video encoding module.

In one embodiment, one handshaking module is coupled to the video encoding module and said each of said one or more processing modules. In one example, only said one handshaking module accesses said data memory directly. In this case, the front-end processing module writes to the first memory and the video encoding module reads from the data memory through said one handshaking module coupled to the video encoding module and the front-end processing module. or the video encoding module writes to the second memory and the post-end processing module reads from the second memory through said one handshaking module coupled to the video encoding module and the post-end processing module. In another example, said one handshaking module does not access said data memory directly. In this case, the front-end processing module writes to and the video encoding module reads from the first memory directly, or the video encoding module writes to and the post-end processing module reads from the second memory directly. In yet another example only said one handshaking module and one of the video encoding module and said one or more processing modules associated with said one data memory access said data memory directly. In this case, the front-end processing module writes to the first memory directly and the video encoding module reads from the first memory through said one handshaking module coupled to the video encoding module and the front-end processing module, or the video encoding module writes to the second memory directly and the post-end processing module reads from the second memory through said one handshaking module coupled to the video encoding module and the post-end processing module. Alternatively, the front-end processing module writes to the first memory through said one handshaking module coupled to the video encoding module and the front-end processing module and the video encoding module reads from the first memory directly, or the video encoding module writes to the second memory through said one handshaking module coupled to the video encoding module and the post-end processing module and the post-end processing module reads from the second memory directly.

In another embodiment, a first handshaking module is coupled to the video encoding module and a second handshaking module is coupled to said each of said one or more processing modules. Furthermore, only the first handshaking module and the second handshaking module access the first memory or the second memory directly. In this case, the front-end processing module writes to the first memory through the second handshaking module and the video encoding module reads from the first memory through the first handshaking module, or the video encoding module writes to the second memory through the first handshaking module and the post-end processing module reads from the second memory through the second handshaking module.

### BRIEF DESCRIPTION OF THE DRAWINGS

FIG. 1 illustrates an example of a video link from a source to a sink involving video encoding at the source end and video decoding at the sink end.

FIG. 2A illustrates an example of video recording path in the recording system, where the video source is encoded using video encoder to generate video bitstream.

FIG. 2B illustrates an example of video playback path in a playback system, where the compressed A/V data are de-multiplexed by de-multiplexer (DEMUX) to extract the video bitstream, which is provided to video decoder to generate reconstructed frames for display.

FIG. 3 illustrates an exemplary adaptive Inter/Intra video coding system incorporating loop processing.

FIG. 4 illustrates a system block diagram of a corresponding video decoder for the encoder system in FIG. 3.

FIG. 5 illustrates an example of spatial and temporal prediction.

FIG. 6 illustrates an example of HEVC wavefront parallel processing (WPP).

FIG. 7A illustrates an example of coding process for a video encoder incorporating an embodiment of the present invention, where the video input is written to memory in a line by line fashion and the CTU size is assumed to be 32×32.

FIG. 7B illustrates an example of coding process for a video encoder incorporating an embodiment of the present invention, where the video input is written to memory in a CTU by CTU fashion and the CTU size is 32×32.

FIG. 8 illustrates an example of using a ring buffer for slice-based video encoder output and the multiplexer input.

FIG. 9 illustrates an example of slice data mapping to the ring buffer for an 8-entry slice ring buffer.

FIG. 10 illustrates an exemplary encoder system based on the encoder in FIG. 3, where the present system incorporates a CTU bases source buffer and a slice-based ring buffer.

FIG. 11 illustrates an example of applying the present invention to a video encoding system with the wave-front parallel processing (WPP) feature.

FIG. 12 illustrates an example of a video encoding system incorporating a first memory for shared data access between the ISP and the video encoder and incorporating a second memory for shared data access between the video encoder and the multiplexer.

FIG. 13A illustrates one handshaking mechanism according to the present invention, where the main module communicates with the handshaking module for handshaking information and notification and also the main module accesses the data from/to the data memory.

FIG. 13B illustrates one handshaking mechanism according to the present invention, where the main module communicates with the handshaking module for handshaking information and notification and only the handshaking module accesses the data from/to the data memory.

FIG. 14 illustrates another example of handshaking mechanism, where a common handshaking module handles the handshaking mechanism for main module A and main module B, and only the handshaking module accesses the data memory.

FIG. 15 illustrates yet another example of handshaking mechanism according to one embodiment of the present invention, where a common handshaking module is used and only the common handshaking module access the data memory directly.

FIG. 16 illustrates yet another example of handshaking mechanism according to one embodiment of the present invention, where a common handshaking module is used and only the common handshaking module and main module B access the data memory directly.

FIG. 17 illustrates yet another example of handshaking mechanism according to one embodiment of the present invention, where a common handshaking module is used and only the common handshaking module and main module A access the data memory directly.

FIG. 18 illustrates yet another example of handshaking mechanism according to one embodiment of the present invention, where two separate handshaking modules handle the handshaking mechanism for main module A and main module B separately.

FIG. 19 illustrates a flowchart of an exemplary coding system according to an embodiment of the present invention to achieve low latency.

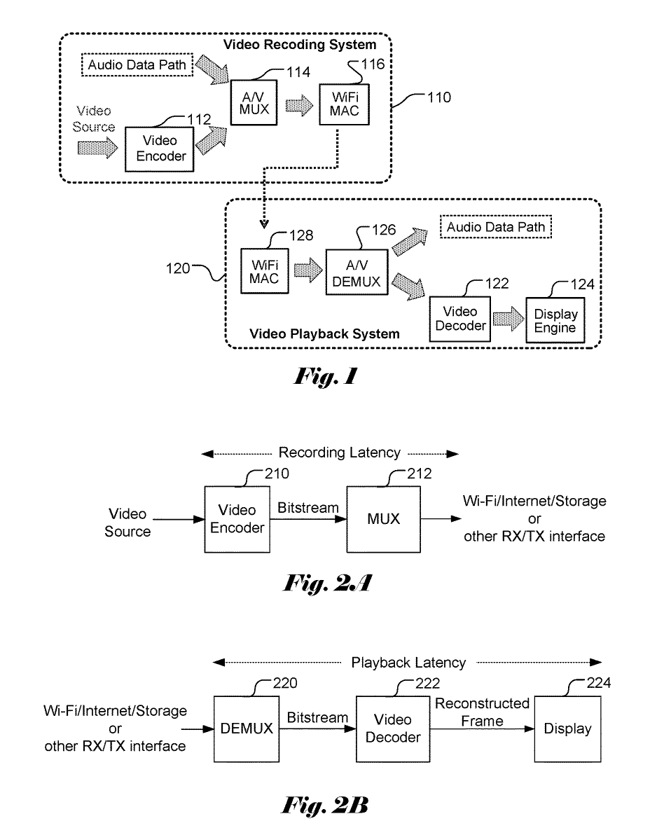

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

In order to reduce the latency in the recording/transmission side, the playback/receiving side or the total latency on both sides of a video link, the present invention discloses a system that coordinates data access and process timing among different processing modules of the system.

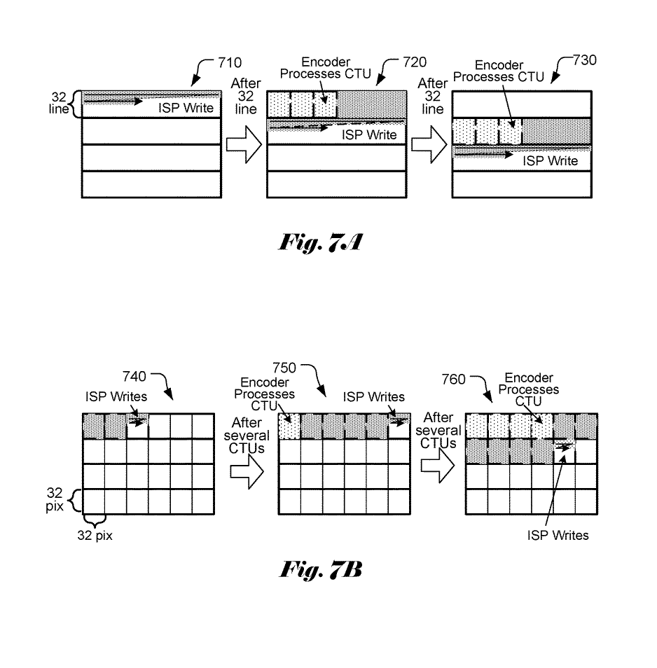

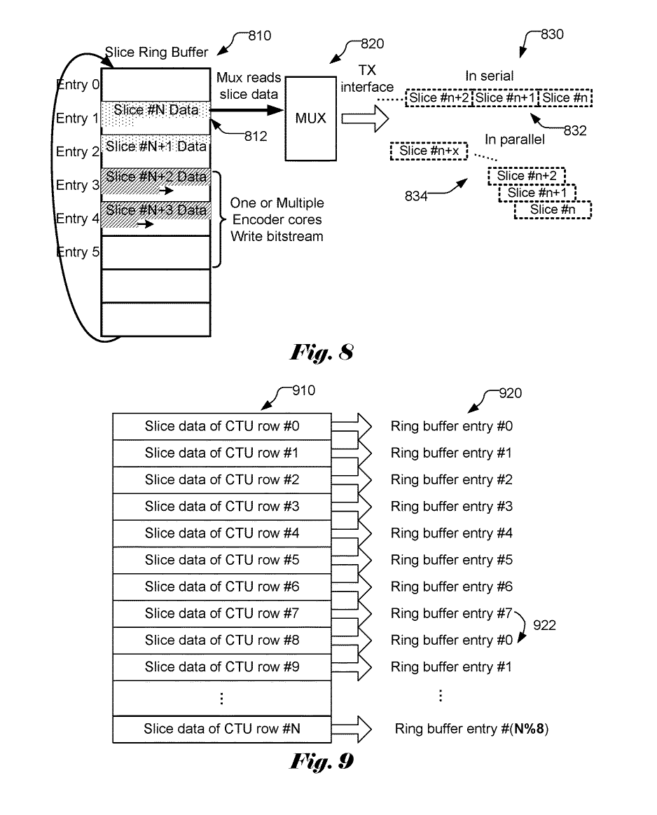

FIG. 7A illustrates an example of coding process for a video encoder incorporating an embodiment of the present invention, where the video input is written to memory in a line by line fashion and the CTU size is assumed to be 32×32. In FIG. 7A, source buffer state 710 corresponds to the period that the image signal processing (ISP) module writes image data line by line into picture buffer 710 in a rater scan order during the first 32 lines. After the first 32 lines in the memory are filled, the video encoder can start to encode the first CTU in the first CTU row while the ISP continues to write data into the second 32 lines as indicated by source buffer state 720. After the second 32 lines in the memory are filled, the video encoder can start to encode the first CTU in the second CTU row while the ISP continues to write data into the third 32 lines as indicated by source state 730. FIG. 7A illustrates an example of tightly couple source buffer control, where the encoder starts the coding process on a CTU whenever one or more CTU is ready, which is also called encoder source racing in this disclosure. It is noted that the source buffer doesn't have to hold a whole picture. When a CTU row is processed by the encoder, the space for the CTU row may be released and reused.

FIG. 7B illustrates an example of coding process for a video encoder incorporating an embodiment of the present invention, where the video input is written to memory in a CTU by CTU fashion and the CTU size is 32×32. In FIG. 7B, the ISP writes video data into source buffer during the first few CTUs as indicated by source buffer state 740. When one or more CTUs are ready in the source buffer, the encoder may start to process the first CTU in the CTU row as indicated by source buffer state 750. Both the ISP and the video encoder continue to process data with ISP writing a CTU that is several CTUs ahead of the CTU being encoded. Source buffer state 760 shows that the ISP is writing to a CTU in the second CTU row while the video encoder is encoding a CTU in the first CTU row.

After the video data are encoded, the bitstream is multiplexed with audio data. The present invention further discloses techniques to manage the data access and processing timing between the encoder module and the multiplexer module. FIG. 8 illustrates an example of using a ring buffer 810 for slice-based video encoder output and the multiplexer input. The encoder writes each bitstream for a slice into one independent buffer entry of the ring buffer. The bitstreams for slices are written into the buffer entries of the ring buffer continuously. The write pointer to the multiplexer is updated when the bitstream for a slice is finished. For example, when slice #N data 812 are being processed by the multiplexer 820, the write pointer points to Entry 1 of the slice ring buffer. After slice #N data 812 are processed, the pointer is updated to the next entry (i.e., Entry 2). The multiplex 820 reads one or more slice data that are ready from the slice ring buffer 810 immediately and send to transmission interface. At this time said one or more slice data are considered complete and the multiplexer updates and informs the read pointer to encoder. The output 830 from the multiplexer 820 is also shown in FIG. 8. The output may corresponds to serial output 832 or parallel output 834.

FIG. 9 illustrates an example of slice data mapping to the ring buffer for an 8-entry slice ring buffer. The slice data 910 generated from the encoder are shown on the left hand side. The mapped ring buffer entries 920 for the slice data are shown on the right hand side. As shown in this example, slice data of CTU row #7 is written to ring buffer entry #7. The next slice data (i.e., #8) of CTU row is written to ring buffer entry #0. In this example, each CTU row is treated as one slice.

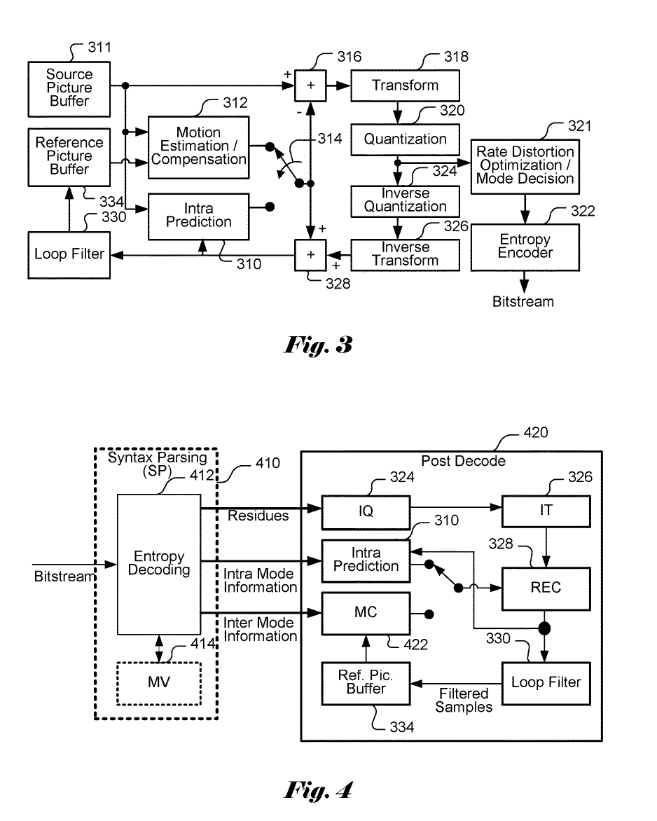

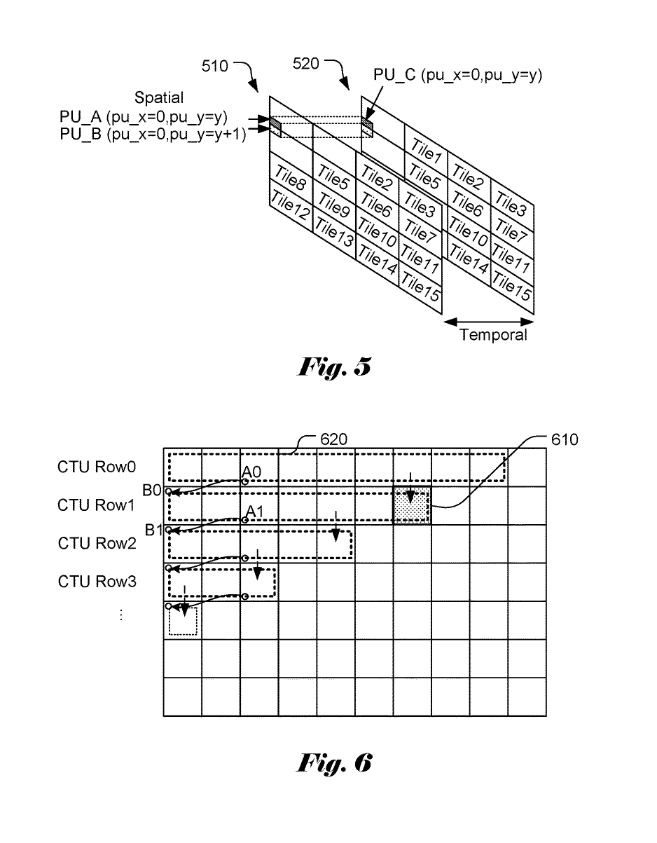

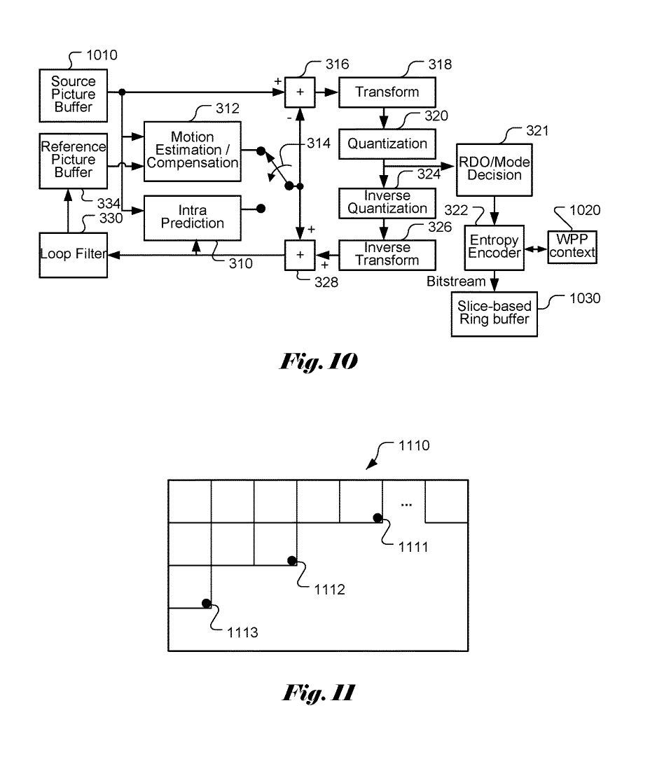

FIG. 10 illustrates an exemplary encoder system based on the encoder in FIG. 3, where the present system incorporates a CTU bases source buffer 1010 and a slice-based ring buffer 1030. Furthermore, a context buffer 1020 is used to store data from a previous CTU row required to form context for context-based entropy coding.

FIG. 11 illustrates an example of applying the present invention to a video encoding system with the wave-front parallel processing (WPP) feature. Frame 1110 is partitioned into coding units or any coding blocks, where each small block corresponds to one data unit used for coding process. As is known in the video coding field, the data unit may correspond to a macroblock (MB), a super MB (SB), a coding tree unit (CTU), or a Coding Unit (CU) as defined in the HEVC coding standard. The first coding unit set corresponds to a coding unit row. The coding units from different coding unit rows that can be parallel encoded according to the WPP features are indicated by a dot (1111, 1112 or 1113).

The use of source buffer between the image signal processing (ISP) module and the video encoder for shared data access has been described earlier. Also, the use of slice-based ring buffer for shared data access between the video encoder and the multiplexing module has been described earlier. For the video encoding path, the ISP is considered as the front-end module to the video encoder and the multiplexer is considered as a post-end module to the video encoder. FIG. 12 illustrates an example of a video encoding system incorporating a first memory 1210 for shared data access between the ISP 1220 and the video encoder 1230 and incorporating a second memory 1240 for shared data access between the video encoder 1230 and the multiplexer 1250. For example, the first memory 1210 may correspond to the source buffer and the second memory 1240 may correspond to the slice-based ring buffer as disclose before. However, other types of memory design to facilitate the shared memory access to achieve the low-latency video coding can also be used.

The operations of video coding system incorporating embodiments of the present invention to achieve low latency are described as follows. For the image signal processing module 1220, it writes the data of the first coding unit set into the first memory 1210 and communicates with the video encoder 1230 with handshaking mechanism. The video encoder 1230 is informed when the data of the first coding unit set is ready for reading. For video encoder 1230, it encodes the data of the first coding unit set into the first bit-stream and writes the first bit-stream into the second memory 1240. The first bit-stream may be packed into a network abstraction layer unit and the packed first bit-stream is written into a second memory. The video encoder 1230 also communicates with multiplexing module 1250 with handshaking mechanism and the multiplexing module 1250 is informed when the first bit-stream is ready for reading. For the multiplexing module 1250, it reads the packed first bit-stream from the second memory 1240 and transmits the first bit-stream to an interface, such as a Wi-Fi module, for network transmission. The video link may correspond to a video recording and video playback system. In this case, the multiplexing module 1250 reads the packed first bitstream from the second memory 1240 and stores it into a storage device.

In FIG. 11, a video frame is partitioned into coding unit rows or block rows. A video segment that may be smaller than a frame, such as a tile, can also be used as an input unit to the encoding system. Therefore, a video frame may comprise multiple video segments. Each coding unit set may correspond to an independent slice or a dependent slice. In FIG. 12, the video encoder 1220 may start to encode the pixel data of the first coding unit set after the front-end module (e.g. the ISP) completes writing all the pixel data of the first coding unit set into the first memory. While the ISP is used as an example of the front-end module, other types of front-end processor may also be used.

The size of the first bit-stream can be limited to a maximum size and the maximum size can be determined before encoding a video segment. The maximum size can be determined based on the capability of the video decoder or the network.

The first memory corresponds to a source buffer. According to one embodiment of the present invention, a ring buffer with a fixed size can be used. When the front-end module writes video data to the first memory, the video data can be written in a line by line fashion or a block by block fashion. In the case of line-based data write, the video encoder may start to encode blocks in a block row when all video lines in the block row are ready. In the case of block-based data write, the video encoder may start to encode the first block in a block row when one or more blocks in the block row are ready. The block may correspond to a CTU, a CU, a SB or MB. The second memory corresponds to a compressed video data buffer. According to one embodiment, a ring buffer with a fixed size can be used as the second memory. The post-end module may derive the video index corresponding to the video segment. Also, the post-end module may derive the time stamp corresponding to a video segment.

In FIG. 12, two processing modules (i.e., the ISP and the video encoder) are coupled to the first memory. Also, two processing modules (i.e., the video encoder and the multiplexer) are coupled to the second memory. An example of handshaking mechanism between the two modules, referred as module A and module B for simplicity, is disclosed to support the low latency as follows. For the first memory, module A corresponds to the ISP and the module B corresponds to the video encoder. For the second memory, module A corresponds to the video encoder and module B corresponds to the multiplexer. In one example, handshaking mechanism is as follows:
Module A writes one first data into one data memory;
Module A transmits the write pointer to module B, wherein the write pointer indicates the end point of one first data in one data memory;
Module B receives the write pointer from module A;
Module B reads one first data from one data memory; and
Module B transmits the read pointer to module A, wherein the read pointer indicates the end point of one first data in one data memory.

In another example, handshaking mechanisms is as follows:
Module A writes one first data into one data memory;
Module A transmits one write indication to module B, wherein the write indication indicates one first data is in one data memory;
Module B receives one write indication from module A;
Module B reads one first data from one data memory; and
Module B transmits one read indication to module A, wherein the read indication indicates that one first data is read by module B.

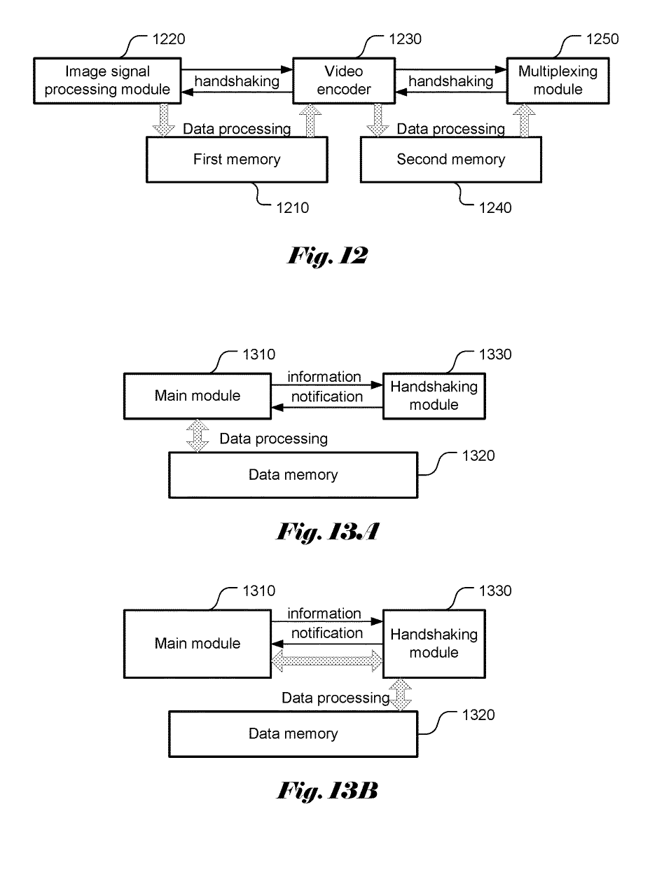

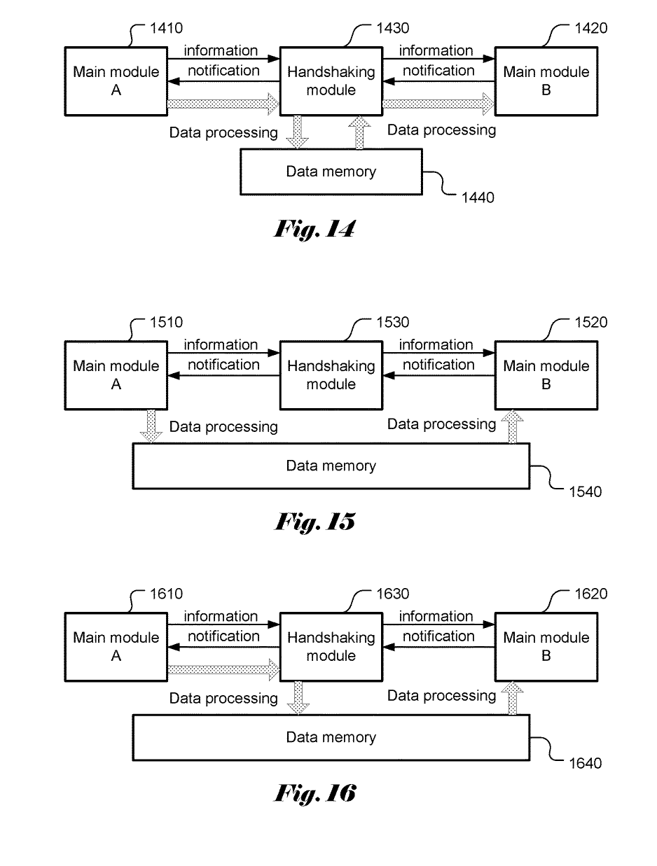

FIG. 13A and FIG. 13B illustrate another handshaking mechanism according to the present invention, where the main module communicates with the handshaking module for handshaking information and notification. In FIG. 13A, the main module 1310 accesses the data from/to the data memory 1320 and the main module 1310 communicates with the handshaking module 1330 for handshaking information and notification. In this example, only main module A 1310 accesses data memory 1340 directly. In FIG. 13B, the handshaking module 1330 accesses the data from/to the data memory 1320 and the main module 1310 communicates with the handshaking module 1330 for handshaking information and notification. In this example, only the handshaking module 1330 accesses data memory 1320 directly.

FIG. 14 illustrates another example of handshaking mechanism according to one embodiment of the present invention, where a common handshaking module 1430 handles the handshaking mechanism for main module A 1410 and main module B 1420. When the data memory 1440 corresponds to the first memory in FIG. 12, main module A 1410 corresponds to the front-end module and main module B 1420 corresponds to the video encoder. When the data memory 1440 corresponds to the second memory in FIG. 12, main module A 1410 corresponds to the video encoder and main module B 1420 corresponds to the multiplexer. In this example, only the handshaking module 1430 accesses data memory 1440 directly.

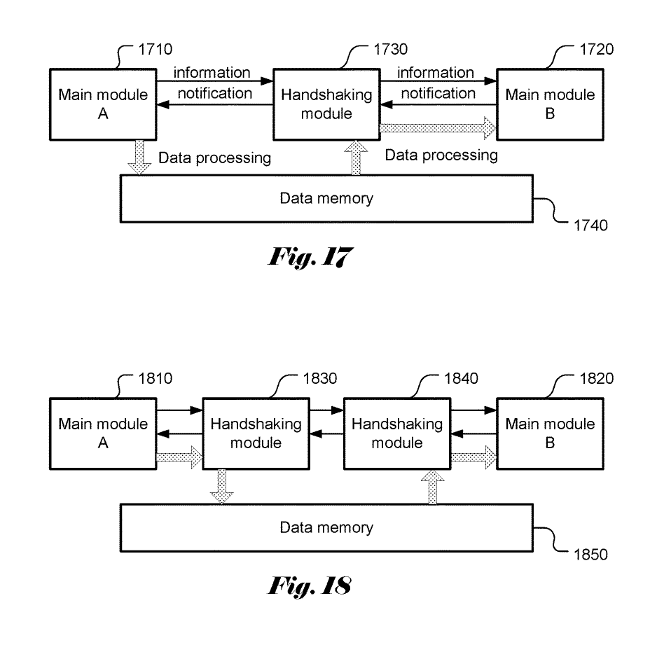

FIG. 15 illustrates yet another example of handshaking mechanism according to one embodiment of the present invention. In this example, a common handshaking module 1530 handles the handshaking mechanism for main module A 1510 and main module B 1520. When the data memory 1540 corresponds to the first memory in FIG. 12, main module A 1510 corresponds to the front-end module and main module B 1520 corresponds to the video encoder. When the data memory 1540 corresponds to the second memory in FIG. 12, main module A 1510 corresponds to the video encoder and main module B 1520 corresponds to the multiplexer. In this example, main module A 1510 and main module B 1520 access data memory 1540 directly.

FIG. 16 illustrates yet another example of handshaking mechanism according to one embodiment of the present invention. In this example, a common handshaking module 1630 handles the handshaking mechanism for main module A 1610 and main module B 1620. When the data memory 1640 corresponds to the first memory in FIG. 12, main module A 1610 corresponds to the front-end module and main module B 1620 corresponds to the video encoder. When the data memory 1640 corresponds to the second memory in FIG. 12, main module A 1610 corresponds to the video encoder and main module B 1620 corresponds to the multiplexer. In this example, both main module B 1620 and the handshaking module 1630 can access the data memory 1640 directly.

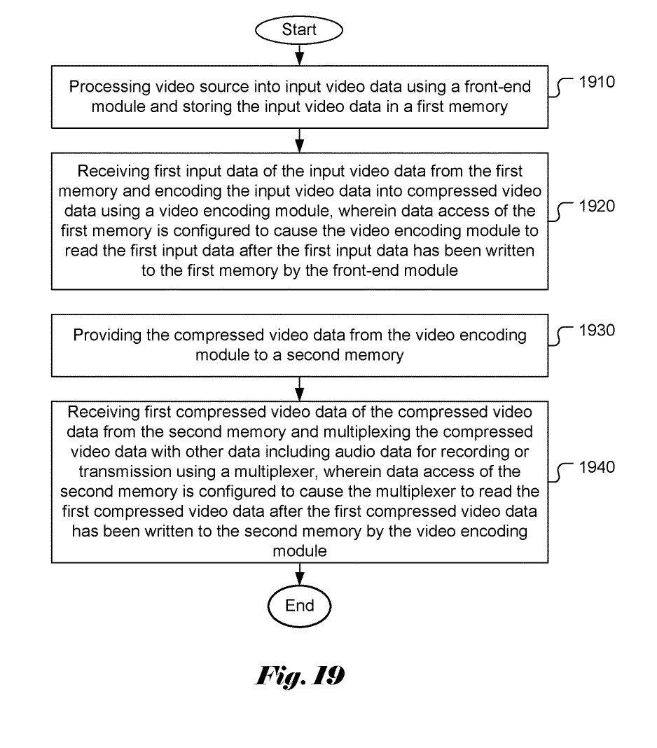

FIG. 17 illustrates yet another example of handshaking mechanism according to one embodiment of the present invention. In this example, a common handshaking module 1730 handles the handshaking mechanism for main module A 1710 and main module B 1720. When the data memory 1740 corresponds to the first memory in FIG. 12, main module A 1710 corresponds to the front-end module and main module B 1720 corresponds to the video encoder. When the data memory 1740 corresponds to the second memory in FIG. 12, main module A 1710 corresponds to the video encoder and main module B 1720 corresponds to the multiplexer. In this example, both main module A 1710 and the handshaking module 1730 can access the data memory 1740 directly.

FIG. 18 illustrates yet another example of handshaking mechanism according to one embodiment of the present invention. In this example, two separate handshaking modules (1830 and 1840) handle the handshaking mechanism for main module A 1810 and main module B 1820 separately. Handshaking module A 1830 is couple to main module A for handling the handshaking information and notification from/to module A. On the other hand, handshaking module B 1840 is couple to main module B 1820 for handling the handshaking information and notification from/to module B 1820. When the data memory 1850 corresponds to the first memory in FIG. 12, main module A 1810 corresponds to the front-end module and main module B 1820 corresponds to the video encoder. When the data memory 1850 corresponds to the second memory in FIG. 12, main module A 1810 corresponds to the video encoder and main module B 1820 corresponds to the multiplexer. In this example, both handshaking modules 1830 and 1840 can access the data memory 1850 directly.

FIG. 19 illustrates a flowchart of an exemplary coding system according to an embodiment of the present invention to achieve low latency. According to this embodiment, video source is processed into input video data using a front-end module and storing the input video data in a first memory as shown in step 1910. FIG. 12 illustrates an example of using a front-end module (i.e., ISP 1220) to generate input video data. First input data of the input video data is received from the first memory and the input video data is encoded into compressed video data using a video encoding module in step 1920, where data access of the first memory is configured to cause the video encoding module to read the first input data after the first input data has been written to the first memory by the front-end module. FIG. 12 illustrates an example of video encoder 1230 and the first memory 1210. Various handshaking mechanisms have been illustrated in FIG. 13 through FIG. 18. The compressed video data from the video encoding module is then provided to a second memory in step 1930. First compressed video data of the compressed video data is received from the second memory and the compressed video data are multiplexed with other data including audio data for recording or transmission using a multiplexer in step 1940, where data access of the second memory is configured to cause the multiplexer to read the first compressed video data after the first compressed video data has been written to the second memory by the video encoding module. The data access can be configured using handshaking module(s) as illustrated in FIG. 13 through FIG. 18.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. An apparatus for video encoding comprising:
a video encoding module to encode input video data into compressed video data;
one or more processing modules to provide the input video data to the video encoding module or to further process the compressed video data from the video encoding module; and
one data memory associated with each of said one or more processing modules to store or to provide shared data between the video encoding module and said each of said one or more processing modules; and
wherein the video encoding module and said each of said one or more processing modules are configured to manage data access of said one data memory by coordinating one of the video encoding module and said each of said one or more processing modules to receive target shared data from said one data memory after the target shared data from another of the video encoding module and said each of said one or more processing modules are ready in said one data memory.

2. The apparatus of claim 1, wherein said one or more processing modules comprise a front-end processing module and said one data memory associated with the front-end processing module corresponds to a first memory, and wherein the front-end processing module provides first pixel data corresponding to a first coding data set of one video segment to store in the first memory and the video encoding module receives and encodes second pixel data corresponding to one or more blocks of the first coding data set of one video segment when said one or more blocks of the first coding data set of one video segment in the first memory are ready.

3. The apparatus of claim 2, wherein the first coding data set of one video segment is encoded by the video encoding module into a first bitstream.

4. The apparatus of claim 3, wherein a size of the first bitstream is limited to be equal to or smaller than a maximum size, and wherein the maximum size is determined before encoding the first coding data set of one video segment.

5. The apparatus of claim 4, wherein the maximum size is determined based on decoder capability, recording capability or network capability associated with a target video decoder, a target video recording device or a target network that is capable of handling compressed video data.

6. The apparatus of claim 2, wherein the front-end processing module corresponds to an ISP (image signal processing) module, the first memory corresponds to a source buffer and the first coding data set of one video segment corresponds to a block row, and wherein the ISP module provides the first pixel data on a line by line basis and the video encoding module starts to encode one or more blocks of the first coding data set of one video segment after the first pixel data for the block row are all stored in the first memory.

7. The apparatus of claim 2, wherein the front-end processing module corresponds to an ISP (image signal processing) module, the first memory corresponds to a source buffer and the first coding data set of one video segment corresponds to a block row, and wherein the ISP module provides the first pixel data on a block by block basis and the video encoding module starts to encode one block of the first coding data set of one video segment after the first pixel data for a number of blocks are stored in the first memory.

8. The apparatus of claim 2, wherein the first memory corresponds to a ring buffer with a fixed size smaller than a video segment.

9. The apparatus of claim 2, wherein each video frame comprises one or more video segments.

10. The apparatus of claim 2, wherein the first coding data set of one video segment comprises a plurality of coding units.

11. The apparatus of claim 2, wherein the first coding data set of one video segment corresponds to a CTU (coding tree unit) row, a CU (coding unit) row, an independent slice or a dependent slice.

12. The apparatus of claim 2, wherein said one or more processing modules further comprise a post-end processing module and said one data memory associated with the post-end processing module corresponds to a second memory, and wherein the video encoding module provides packed first bitstream corresponding to compressed data of the first coding data set of one video segment to store in the second memory and the post-end processing module processes the packed first bitstream for recording or transmission after the packed first bitstream in the second memory are ready.

13. The apparatus of claim 12, wherein the post-end processing module corresponds to a multiplexer module, and wherein the multiplexer module multiplexes the packed first bitstream with other data including audio data into multiplexed data for recording or transmission.

14. The apparatus of claim 13, wherein the multiplexer module derives one video channel index or time stamp corresponding to the said video segment to include in the multiplexed data.

15. The apparatus of claim 13, wherein the second memory corresponds to a ring buffer.

16. The apparatus of claim 12, wherein a write pointer or indication corresponding to an end point of one first data unit in one data memory being written is signaled from the front-end processing module to the video encoding module or from the video encoding module to the post-end processing module.

17. The apparatus of claim 16, wherein a read pointer or indication corresponding to an end point of one second data unit in one data memory being read is signaled from the video encoding module to the front-end processing module or from the post-end processing module to the video encoding module.

18. The apparatus of claim 12, wherein one handshaking module is coupled to the video encoding module and said each of said one or more processing modules.

19. The apparatus of claim 18, wherein only said one handshaking module accesses said data memory directly, and wherein the front-end processing module writes to the first memory and the video encoding module reads from the data memory through said one handshaking module coupled to the video encoding module and the front-end processing module, or the video encoding module writes to the second memory and the post-end processing module reads from the second memory through said one handshaking module coupled to the video encoding module and the post-end processing module.

20. The apparatus of claim 18, wherein said one handshaking module does not access said data memory directly, and wherein the front-end processing module writes to and the video encoding module reads from the first memory directly, or the video encoding module writes to and the post-end processing module reads from the second memory directly.

21. The apparatus of claim 18, wherein only said one handshaking module and one of the video encoding module and said one or more processing modules associated with said one data memory access said data memory directly, and wherein the front-end processing module writes to the first memory directly and the video encoding module reads from the first memory through said one handshaking module coupled to the video encoding module and the front-end processing module, or the video encoding module writes to the second memory directly and the post-end processing module reads from the second memory through said one handshaking module coupled to the video encoding module and the post-end processing module.

22. The apparatus of claim 18, wherein only said one handshaking module and one of the video encoding module and said one or more processing modules associated with said one data memory access directly with said data memory, and
wherein the front-end processing module writes to the first memory through said one handshaking module and the video encoding module reads from the first memory directly, wherein said one handshaking module is coupled to the video encoding module and the front-end processing module; or
wherein the video encoding module writes to the second memory through said one handshaking module and the post-end processing module reads from the second memory directly, wherein said one handshaking module is coupled to the video encoding module and the post-end processing module and the post-end processing module.

23. The apparatus of claim 12, wherein a first handshaking module is coupled to the video encoding module and a second handshaking module is coupled to said each of said one or more processing modules, and wherein the front-end processing module writes to the first memory through the second handshaking module and the video encoding module reads from the first memory through the first handshaking module, or the video encoding module writes to the second memory through the first handshaking module and the post-end processing module reads from the second memory through the second handshaking module.

24. A method of video encoding comprising:
processing video source into input video data using a front-end module and storing the input video data in a first memory;
receiving first input data of the input video data from the first memory and encoding the input video data into compressed video data using a video encoding module, wherein data access of the first memory is configured to cause the video encoding module to read the first input data after the first input data has been written to the first memory by the front-end module;
providing the compressed video data from the video encoding module to a second memory; and
receiving first compressed video data of the compressed video data from the second memory and multiplexing the compressed video data with other data including audio data for recording or transmission using a multiplexer, wherein data access of the second memory is configured to cause the multiplexer to read the first compressed video data after the first compressed video data has been written to the second memory by the video encoding module.
